(19) United States
(12) Patent Application Publication
(10) Pub. No.: US 2021/0181803 A1
(43) Pub. Date: Jun. 17, 2021

(54) LAPTOP DISPLAY SCREEN SUPPORT DEVICE

(71) Applicant: Anjum Gupta, San Diego, CA (US)

(72) Inventor: Anjum Gupta, San Diego, CA (US)

(21) Appl. No.: 16/710,741

(22) Filed: Dec. 11, 2019

(51) Int. Cl. G06F 1/16

(52) U.S. Cl. CPC G06F 1/1675; G06F 1/1616; G06F 1/1637

(57) ABSTRACT

The disclosure provides a laptop display screen supporting device. The device includes a pair of support arms, each arm having a proximal end rotatably attached to a side of a laptop body, and a distal end attached to a side of the display screen, wherein the support arms can rotate the display screen from a closed position to an opened position. The device also includes a means for raising and lowering the display screen along the pair of support arms while in the opened position.

### FIELD OF THE INVENTION

The present disclosure generally relates to laptop computers, and more particularly, to laptop display screen supporting devices that can be used to raise and lower a laptop computer display screen above a base surface.

### BACKGROUND OF THE INVENTION

In recent years, there has been a tremendous growth in the sale of laptop computers and notebook computers. Laptop computers are very useful instruments, which essentially present a computer to the user in a convenient compact fashion. Typically, the screen of the laptop computer is a liquid crystal display. The screen of the laptop computer can fold upon the body of the computer so as to close when not in use. When the laptop computer is in use, the screen is folded about its hinges so as to face the user. The bottom surface of the laptop computer is typically placed on a table, on a lap, or other flat surface. Various devices such as power supplies, modems, external drives, and other items can also be connected to the laptop computer so as to enhance the use of the laptop computer.

While the design of the laptop computer is optimized for compactness and convenience, but not necessarily for optimum ergonomic efficiency. When the laptop computer is placed on a flat surface, the screen of the laptop computer often does not face the user directly. As such the user of the laptop computer must slouch or otherwise manipulate the screen so as to be in an optimal viewing position. The screen at this angle can also reflect an undesirable glare from overhead lighting. Therefore, there remains a need in the art for devices and methods for supporting a laptop display screen for the convenience of the user.

### SUMMARY OF THE INVENTION

The disclosed embodiments are directed to solving one or more of the problems presented in the prior art, as well as providing additional features that will become readily apparent by reference to the following detailed description when taken in conjunction with the accompanying drawings.

Thus, in an embodiment, the disclosure provides a laptop display screen supporting device, having a pair of support arms, each support arm having a proximal end and a distal end, each proximal end rotatably attachable to a side of a laptop body and each distal end attachable to a side of the display screen, wherein the pair of support arms can rotate the display screen from a closed position to an opened position about a lateral axis through the laptop body and proximal ends; and a means for raising and lowering the display screen along the pair of support arms while in the opened position.

In one embodiment, the means for raising and lowering the display screen includes a rack and pinion mechanism.

In other embodiments, the means for raising and lowering the display screen includes a bolt and nut mechanism.

In other embodiments, the means for raising and lowering the display screen includes a spring mechanism.

In other embodiments, the means for raising and lowering the display screen includes a friction slide mechanism.

### BRIEF DESCRIPTION OF THE DRAWINGS

The disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 provides a perspective view of an opened laptop computer with a laptop display screen supporting device of a rack and pinion mechanism with the display screen shown in the lowered position in accordance with an embodiment of the invention;

FIG. 2 provides a perspective view of an opened laptop computer with a laptop display screen supporting device of a rack and pinion mechanism with the display screen as shown in the raised position in accordance with an embodiment of the invention;

FIG. 3 provides a perspective view of an opened laptop computer with a laptop display screen supporting device of a nut and bolt mechanism with the display screen shown in the lowered position in accordance with an embodiment of the invention;

FIG. 4 provides a perspective view of an opened laptop computer with a laptop display screen supporting device of a nut and bolt mechanism with the display screen shown in the raised position in accordance with an embodiment of the invention;

FIG. 5 provides a perspective view of an opened laptop computer with a laptop display screen support device of a spring mechanism with the display screen shown in the lowered position in accordance with one embodiment of the invention;

FIG. 6 provides a perspective view of an opened laptop computer with a laptop display screen support device of a spring mechanism with the display screen shown in the raised position in accordance with one embodiment of the invention;

FIG. 7 provides a perspective view of an opened laptop computer with a laptop display screen support device of a friction slider mechanism with the display screen shown in the lowered position in accordance with one embodiment of the invention; and

FIG. 8 provides a perspective view of an opened laptop computer with a laptop display screen support device of a friction slider mechanism with the display screen shown in the raised position in accordance with one embodiment of the invention.

Further features and advantages of the disclosure, as well as the structure and operation of various embodiments of the disclosure, are described in detail below with reference to the accompanying drawings.

### DETAILED DESCRIPTION OF THE EMBODIMENTS OF THE INVENTION

The following description is presented to enable a person of ordinary skill in the art to make and use embodiments described herein. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the disclosure. Thus, the disclosure is not intended to be limited to the examples described herein and shown, but is to be accorded the scope consistent with the claims.

The word “exemplary” is used herein to mean “serving as an example illustration.” Any aspect or design described herein as “exemplary” is not necessarily to be construed as preferred or advantageous over other aspects or designs.

It should be understood that the specific order or hierarchy of steps in the process disclosed herein is an example of exemplary approaches. Based upon design preferences, it is understood that the specific order or hierarchy of steps in the processes can be rearranged while remaining within the scope of the disclosure. Any accompanying method claims present elements of the various steps in a sample order and are not meant to be limited to the specific order or hierarchy presented.

As used herein, the term “laptop computer” can include various types of small portable computers. For example, the term “laptop computer” can include laptops, notebook and sub-notebook computers, palm-top computers, word processors, pocket computers and electronic organizers, and micro-computers, as well as keyboards and keyboard substitutes such as keypads and electronic writing and drawing pads for pen-based computing.

The disclosure provides a laptop display screen supporting device having a pair of support arms, each support arm having a proximal end and a distal end, each proximal end rotatably attachable to a side of a laptop body and each distal end attachable to a side of the display screen, wherein the pair of support arms can rotate the display screen from a closed position to an opened position about a lateral axis through the laptop body and proximal ends; and a means for raising and lowering the display screen along the pair of support arms while in the opened position.

In some embodiments, the laptop display screen supporting device includes having the pair of supporting arms and attached display screen rotating about the lateral axis from about 0 degrees to about 180 degrees.

In some embodiments, the laptop display screen supporting device includes having each distal end of the pair of support arms can rotate the display screen about a lateral axis through the display screen and distal ends.

In some embodiments, the laptop display screen supporting device includes having each distal end being interconnected.

In some embodiments, the laptop display screen supporting device includes having the display screen between 10 inches and 18 inches.

In some embodiments, the laptop display screen supporting device includes having the display screen being 10.1, 11.6, 12.1, 13.3, 14.0, 15.6, 16.0 or 17.3 inches.

In some embodiments, the laptop display screen supporting device includes having the pair of support arms being each independently made of plastic, polymer, fiberglass, carbon fiber, composite, metal, or a metal alloy.

Reference will now be made in detail to aspects of the subject technology, examples of which are illustrated in the accompanying drawings, wherein like reference numerals refer to like elements throughout.

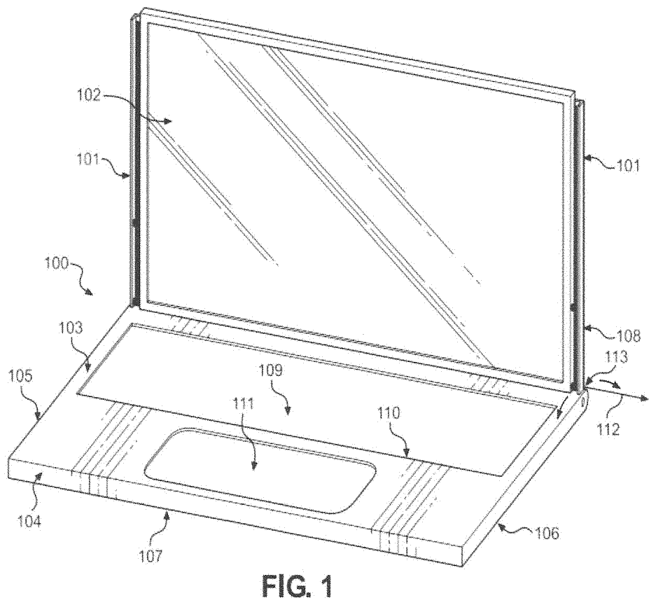

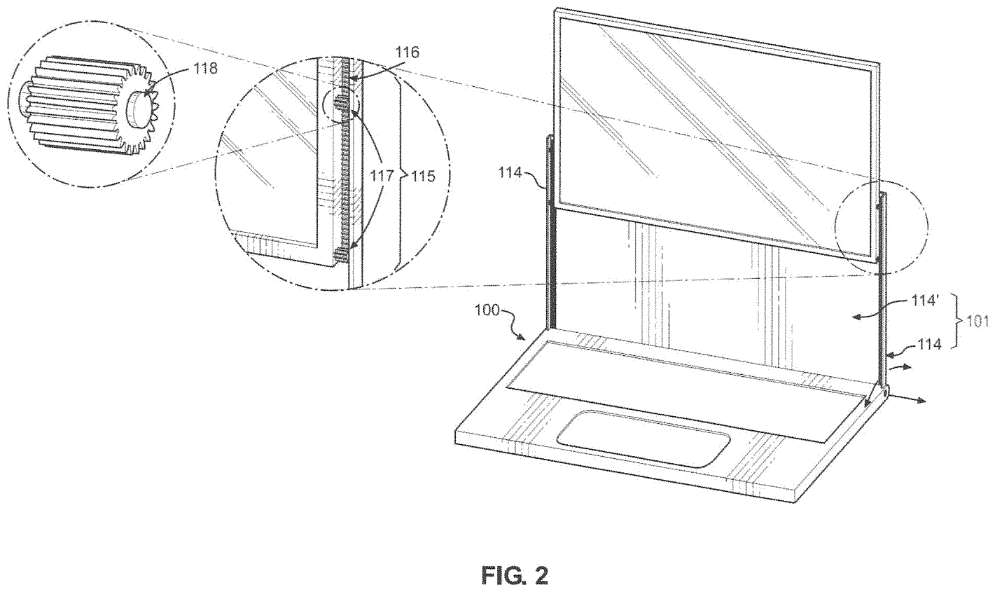

FIG. 1 provides a perspective view of an embodiment of an opened laptop computer 100 with a laptop display screen supporting device 101 of a rack and pinion mechanism 115 with the display screen 102 shown in the lowered position; and FIG. 2 provides a perspective view of an embodiment of an of an opened laptop computer 100 with a laptop display screen supporting device 101 of a rack and pinion mechanism 115 with the display screen 102 shown in the raised position.

As used herein, all description of the sides of the laptop computer are with respect to a user's point of view while in front of the computer during normal operation. Thus, as shown in these figures, the laptop computer 100 includes a laptop display screen supporting device 101, a display screen 102 and a base 103, which contains the various electrical components for operation of the computer. The base 103 includes a front side 104, a left side 105, a right side 106, a bottom side 107, a rear side 108, and a top side 109. The top side includes a keyboard 110, a touchpad 111, and which is pivotally attached the display screen 102. As with most laptop computers, the display screen 102 can rotate along a lateral axis 112 through the base 103 by a hinge mechanism 113 attachable to a pair of support arms 114, so that so that the display screen 102 can rotate between a closed position (˜0 degrees) through to fully opened position (˜180 degrees). In some embodiments, the pair of support arms 114 include an optional back plate 114′ for support of the display screen 102.

As shown in FIG. 2, the laptop display screen supporting device 101 includes a rack and pinion mechanism 115, which includes one or more racks 116 and one or more pinions 117 in each of the pair of support arms 114. The rack and pinion mechanism can be used as a means for raising and lowering the display screen 102. In some embodiments, the pair of support arms 114 can be attached to the display screen 102, wherein when the pinion in each of the pair of support arms rotates or travels along its rack, the display screen can be raised or lowered accordingly. In some embodiments, the rack and pinion mechanism can be manually driven or can be motor driven, for example, by a dowel rod 118 (not shown) through the pinion 117, which can be attached to a manually driven handle (not shown) attached to the dowel rod or by a motor (not shown) attached to dowel rod.

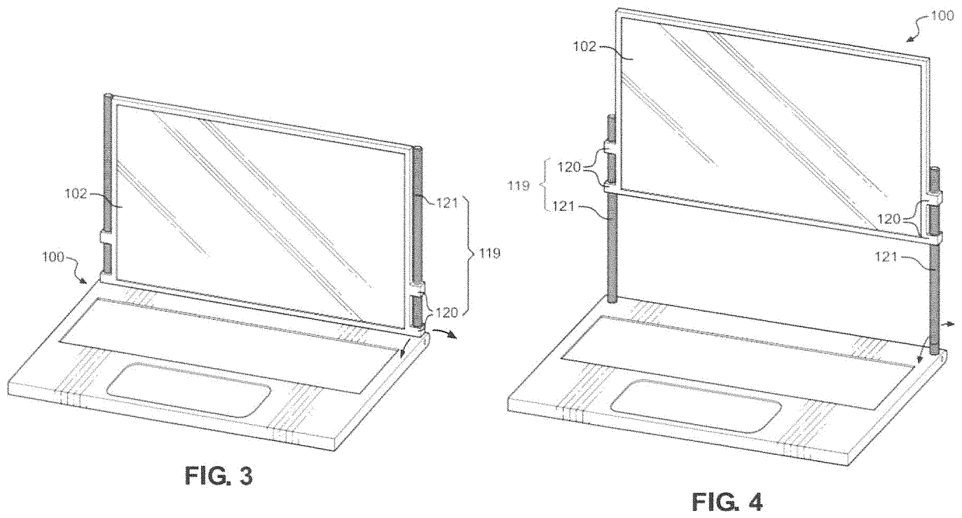

FIG. 3 provides a perspective view of an embodiment of an opened laptop computer 100 with a laptop display screen supporting device 101 of a nut and bolt mechanism 119 with the display screen 102 shown in the lowered position; and FIG. 4 provides a perspective view of an embodiment of an opened laptop computer 100 with a laptop display screen supporting device 101 of a nut and bolt mechanism 119 with the display screen 102 shown in the raised position.

As shown in these figures, the nut and bolt mechanism 119 includes one or more nuts 120 and a bolt 121 in each of the pair of support arms 114 (not shown). In some embodiments, the bolts 121 can act as the pair of support arms. In other embodiments, the support arms 114 cover or incorporate the bolts 121. The nut and bolt mechanism 119 can be used as a means for raising and lowering the display screen 102. In some embodiments, one or more nuts 120 can be attached to the display screen 102, wherein when the bolt 121 in each of the pair of support arms rotates through its nut 120, the display screen 102 can be raised or lowered accordingly. In some embodiments, the nut and bolt mechanism can be manually driven or can be motor driven, for example, by a manually driven handle (not shown) attached to the bolt or by a motor (not shown) attached to the bolt.

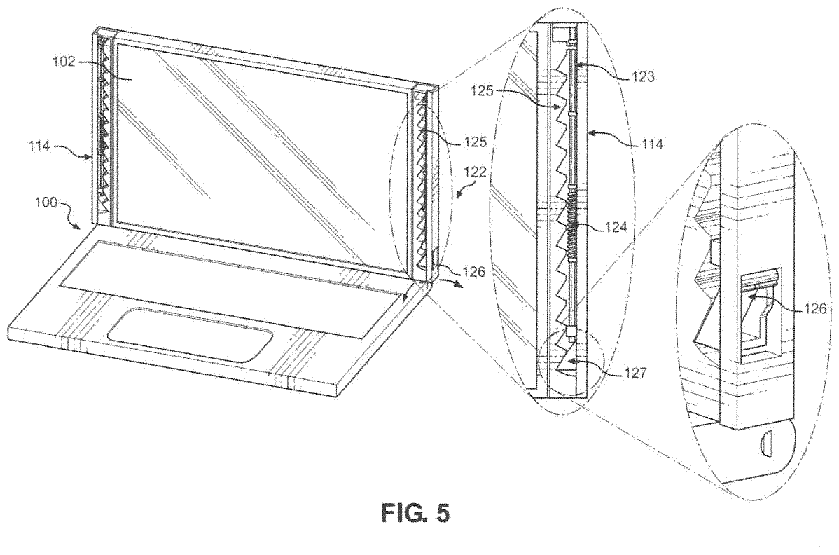

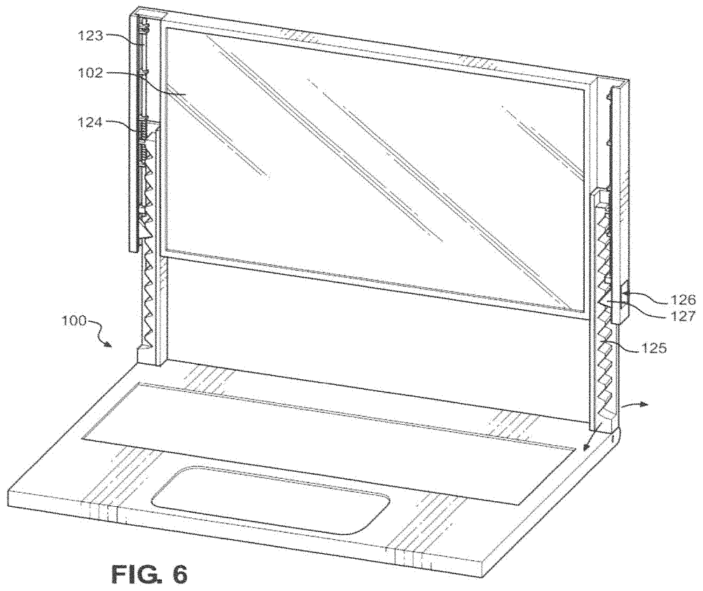

FIG. 5 provides a perspective view of an embodiment of an opened laptop computer 100 with a laptop display screen support device 101 of a spring mechanism 122 with the display screen 102 shown in the lowered position; and FIG. 6 provides a perspective view of an embodiment of an opened laptop computer 101 with a laptop display screen support device 101 of a spring mechanism 122 with the display screen 102 shown in the raised position.

As shown in these figures, the spring mechanism 122 includes a rod 123 and compression spring 124, a step rack 125 and a torsion spring stopper 126 in each of the pair of support arms 114. The spring mechanism 122 can be used as a means for raising and lowering the display screen 102. In some embodiments, the pair of support arms 114 can be attached to the display screen 102. When the torsion spring 126 and stopper 127 are released by pushing down on the rod 123, the rod 123 and compression spring 124 and the pair of support arms 114 can travel up or down the step rack 125 thereby raising or lowering the display screen 102. When the rod 123 is no longer pressed down, the compression spring 124 returns the rod 123 to its original position, and the torsion spring 126 returns the stopper 127 to its original position.

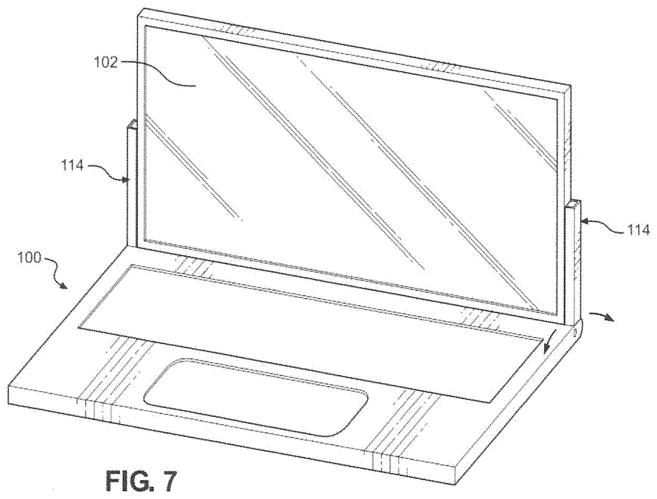

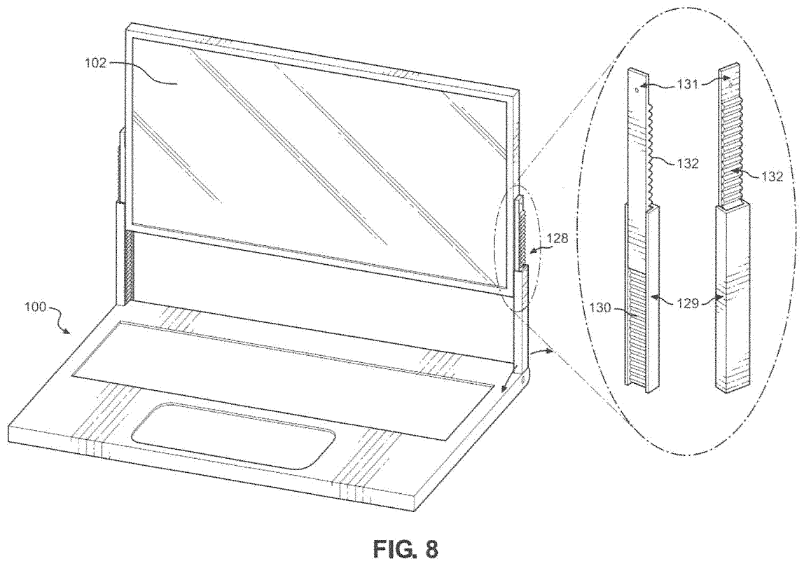

FIG. 7 provides a perspective view of an embodiment of an opened laptop computer 100 with a laptop display screen support device 101 of a friction slider mechanism 128 with the display screen 102 shown in the lowered position; and FIG. 8 provides a perspective view of an embodiment of an opened laptop computer 100 with a laptop display screen support device 101 of a friction slider mechanism 128 with the display screen 102 shown in the raised position.

As shown in these figures, the friction slider mechanism 128 includes a fixed bar 129 with a first set of interlocking teeth 130, and a slider bar 131 with a second set of interlocking teeth 132 in each pair of support arms 114. In some embodiments, the fixed bars 129 can act as the pair of support arms 114. In other embodiments, the support arms 114 cover or incorporate the fixed bars 130. The friction slider mechanism 128 can be used as a means for raising and lowering the display screen 102. In some embodiments, the slider bars 131 can be attached to the display screen 102. When the fixed bars 129 and first set of interlocking teeth 132 are pulled apart from the slider bars 131 and second set of interlocking teeth 131, the display screen 102 can be raised or lowered. Reversing this procedure, secures the display screen 102 in the raised or lowered position.

As described herein, the display screen support device can be used to raise a laptop display screen to provide an elevated view, preferably to near eye level of the user, and conversely, in reverse order, lowered downward to provide the display screen in the standard laptop display screen position.

While the inventive features have been particularly shown and described with reference to preferred embodiments thereof, it will be understood by those in the art that the foregoing and other changes can be made therein without departing from the sprit and the scope of the disclosure. Likewise, the various diagrams may depict an example architectural or other configuration for the disclosure, which is done to aid in understanding the features and functionality that can be included in the disclosure. The disclosure is not restricted to the illustrated example architectures or configurations and can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus, the breadth and scope of the disclosure should not be limited by any of the above-described exemplary embodiments.

What is claimed is:

1. A laptop display screen supporting device, comprising:
a pair of support arms, each support arm having a proximal end and a distal end, each proximal end rotatably attachable to a side of a laptop body and each distal end attachable to a side of the display screen, wherein the pair of support arms can rotate the display screen from a closed position to an opened position about a lateral axis through the laptop body and proximal ends; and
a means for raising and lowering the display screen along the pair of support arms while in the opened position.

2. The laptop display screen supporting device of claim 1, further comprising the pair of supporting arms and attached display screen rotating about the lateral axis from about 0 degrees to about 180 degrees.

3. The laptop display screen supporting device of claim 1, wherein each distal end of the pair of support arms can rotate the display screen about a lateral axis through the display screen and distal ends.

4. The laptop display screen supporting device of claim 1, further comprising each distal end being interconnected.

5. The laptop display screen supporting device of claim 1, wherein the display screen is between 10 inches and 18 inches.

6. The laptop display screen supporting device of claim 6, wherein the display screen is 10.1, 11.6, 12.1, 13.3, 14.0, 15.6, 16.0 or 17.3 inches.

7. The laptop display screen supporting device of claim 1, wherein the pair of support arms are each independently made of plastic, polymer, fiberglass, carbon fiber, composite, metal, or a metal alloy.

8. The laptop display screen supporting device of claim 1, further comprising a rack and pinion mechanism in each of the pair of support arms as a means for raising and lowering the display screen.

9. The laptop display screen supporting device of claim 8, further comprising the rack in each of the pair of support arms being attachable to the display screen, wherein the pinion in each of the pair of support arms can rotate, thereby raising or lowering the display screen.

10. The laptop display screen supporting device of claim 8, wherein the rack and pinion mechanism is manually driven or is motor driven.

11. The laptop display screen supporting device of claim 1, further comprising a bolt and nut mechanism in each of the pair of support arms as a means for raising and lowering the display screen.

12. The laptop display screen supporting device of claim 11, wherein the bolt and nut mechanism in each of the pair of support arms includes one or more nuts attachable to the display screen.

13. The laptop display screen supporting device of claim 11, wherein the bolt and nut mechanism is manually driven or is motor driven.

14. The laptop display screen supporting device of claim 1, further comprising a spring mechanism in each of the pair of support arms as a means for raising and lowering the display screen.

15. The laptop display screen supporting device of claim 14, wherein the spring mechanism includes a rod having a compression spring, a step rack attachable to the display screen, and a torsion spring stopper.

16. The laptop display screen supporting device of claim 1, further comprising a friction slide mechanism in each of the pair of support arms as a means for raising and lowering the display screen.

17. The laptop display screen supporting device of claim 16, wherein the friction slide mechanism includes a fixed bar with a first set of interlocking teeth and a slider bar with a second set of interlocking teeth attachable to the display screen.

18. The laptop display screen of claim 17, wherein when an upward or downward force is applied to the slider bar, the force exerted allows the interlocking teeth of the fixed bar and the slider bar to move over each other thereby raising or lowering the display screen, respectively.
